(19) United States
(12) Patent Application Publication
(10) Pub. No.: US 2026/0203736 A1
(43) Pub. Date: Jul. 16, 2026

(54) PAYMENT TRACKING SYSTEM FOR AN OVERLAY NETWORK FOR PAYMENT NETWORKS

(71) Applicant: American Express Travel Related Services Company, Inc., New York, NY (US)

(72) Inventors: Benjamin J. Cane, Phoenix, AZ (US); Prakasam Duraisamy, Phoenix, AZ (US); Tristan M. Fuentes, Mesa, AZ (US); Sunil Patel, Phoenix, AZ (US)

(21) Appl. No.: 19/429,435

(22) Filed: Dec. 22, 2025

Related U.S. Application Data
(63) Continuation of application No. 18/101,740, filed on Jan. 26, 2023, now abandoned.

(51) Int. Cl. G06Q 20/10; G06Q 20/02

(52) U.S. Cl. CPC G06Q 20/10; G06Q 20/023

(57) ABSTRACT

Disclosed are various embodiments for facilitating payments between members of separate payment networks. At least one embodiment can send a payment request to a network hub connected to a supernetwork instance and linked to a first payment network, the payment request specifying an identifier for a recipient institution and an amount of the payment request. Then the embodiment can receive a payment response to the payment request indicating that the payment request is being forwarded to a global transaction router of the supernetwork instance, wherein the response to the payment request comprises at least a supernetwork tracking identifier. The embodiment can then send a tracking request to a transaction tracker service of the supernetwork instance, the tracking request comprising the supernetwork tracking identifier. Then the embodiment can receive a tracking response to the tracking request, the tracking response comprising various tracking information.

### CROSS-REFERENCE TO RELATED APPLICATIONS

This application is a continuation of, and claims priority to and the benefit of, co-pending Non-Provisional patent application Ser. No. 18/101,740, titled “PAYMENT TRACKING SYSTEM FOR AN OVERLAY NETWORK FOR PAYMENT NETWORKS” and filed on Jan. 26, 2023, which is incorporated by reference as if set forth herein in its entirety

### BACKGROUND

Financial institutions use payment networks to send funds to other participating financial institutions. Financial institutions may also be members of other types of payment networks. Moreover, financial institutions may be members of multiple payment networks to offer multiple payment options to customers and to increase the ability of the financial institution to make electronic payments to other financial institutions.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting a payment network according to various embodiments of the present disclosure.

FIG. 2 is a drawing of a supernetwork according to various embodiments of the present disclosure.

FIG. 3 is a flowchart illustrating one example of functionality implemented as portions of an application executed in a computing environment in the super network of FIG. 2 according to various embodiments of the present disclosure.

FIG. 4 is a flowchart illustrating one example of functionality implemented as portions of an application executed in a computing environment in the super network of FIG. 2 according to various embodiments of the present disclosure.

FIG. 5 is a flowchart illustrating one example of functionality implemented as portions of an application executed in a computing environment in the super network of FIG. 2 according to various embodiments of the present disclosure.

FIG. 6 is a flowchart illustrating one example of functionality implemented as portions of an application executed in a computing environment in the super network of FIG. 2 according to various embodiments of the present disclosure.

FIGS. 7A-7D are drawings of various embodiments of user interfaces to display a tracking module in a client device of FIG. 1 according to various embodiments of the present disclosure.

FIG. 8 is a flowchart illustrating one example of functionality implemented as portions of an application executed in a client device of FIG. 1 according to various embodiments of the present disclosure.

FIG. 9 is a flowchart illustrating one example of functionality implemented as portions of an application executed in a client device of FIG. 1 according to various embodiments of the present disclosure.

FIG. 10 is a flowchart illustrating one example of functionality implemented as portions of an application executed in a computing environment in the super network of FIG. 2 according to various embodiments of the present disclosure.

### DETAILED DESCRIPTION

Disclosed are various approaches for tracking payments across a plurality of payment rails. Financial institutions are often members of one or more payment networks, such as real-time payment (RTP) network, Automated Clearing House network (ACH), the Society for Worldwide Interbank Financial Telecommunication (SWIFT) network, Single Euro Payments Area (SEPA), Blockchains (e.g. Bitcoin Network, Ethereum Network, etc.), checking and eChecking networks, card networks (e.g., AMERICAN EXPRESS, MASTERCARD, VISA, etc.), and other types of networks to exchange, process, and/or transfer currency. Generally, as long as two financial institutions are members of the same payment network, they can make payments with each other.

However, there are multiple networks currently available. If two financial institutions are not members or the same network, then they cannot make payments with each other. This can happen when multiple networks are available within the same jurisdiction (e.g., FedNow and THE CLEARING HOUSE in the United States) or when financial institutions are located in different jurisdictions that provide different networks due to regulatory differences and oversight. Accordingly, at least one solution as to when a first financial institution that is a member of a payment network wants to make a payment to a second financial institution that is not a member of the payment network is to utilize a supernetwork that can transact across many networks. This can give rise to the problem of tracking payments as they are processed over a plurality of networks. Typically, a transaction will obtain a unique tracking number for each transfer over a specific network. However, a problem exists with coordinating and tracking how transactions are transferred, processed, and/or routed over a plurality of networks and/or payment rails. Accordingly, this disclosure depicts and describes various embodiments of tracking payments across a plurality of networks and/or payment rails.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

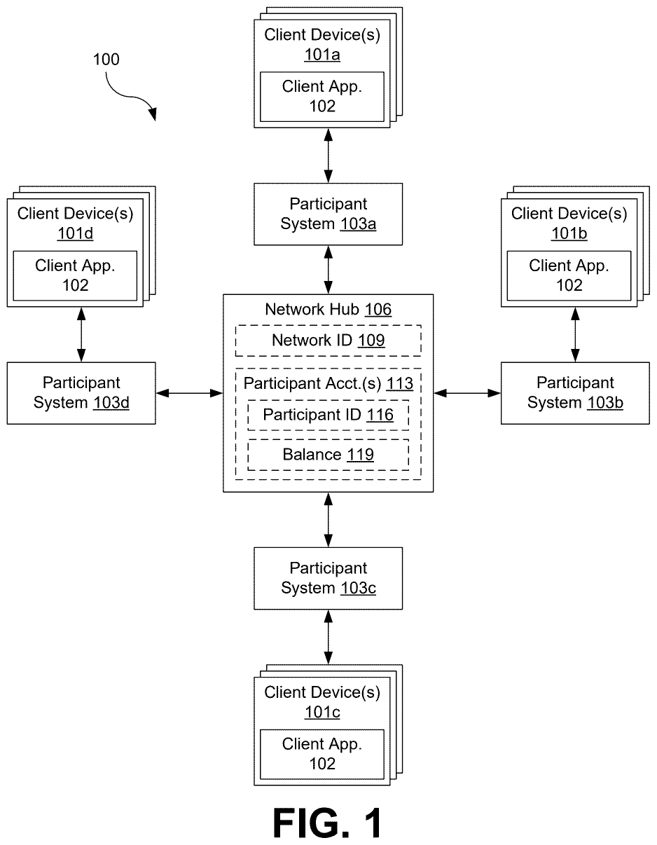

FIG. 1 is a schematic block diagram depicting an example of a payment network 100. A payment network 100 is network of payment rails that allows member institutions to make payments to each other using various types of payments. At least one payment rail in the payment network 100 makes payments with immediate availability at any time. In at least another payment rail, payments may take several days to process and/or may only be made or processed on specific days or hours (e.g., only on business days and/or only during business hours). Examples of payment rails in the payment network 100 in the United States are THE CLEARING HOUSE RTP network offered by The Clearing House and the FEDNOW RTP network offered by the Federal Reserve. Other payment networks 100 may be available in other jurisdictions. Other payment rails may include Automated Clearing House network (ACH), The Society for Worldwide Interbank Financial Telecommunication (SWIFT) network, Single Euro Payments Area (SEPA), Blockchains (e.g. Bitcoin Network, Ethereum Network, etc.), checking and eChecking networks, card networks, and other type of networks to exchange, process, and/or transfer currency.

The payment network 100 can have a number of components, such as one or more client devices (e.g., client devices 101a, client devices 101b, client devices 101c, client devices 101d, etc.), one or more participant systems 103 (e.g., participant system 103a, participant system 103b, participant system 103c, participant system 103d, etc.) and a network hub 106.

The client device 101 is representative of a plurality of client devices 101 (e.g., client devices 101a, 101b, 101c, 101d, etc.). A client device 101 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. In at least some embodiments, a client device 101 can also be embodied in the form of an internet of things (IOT) device, such as an internet-enabled device, like an automobile, a refrigerator, a thermostat, a light switch, or any other device connected to the internet. A client device 101 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of a client device 101 or can be connected to the client device 101 through a wired or wireless connection. A client device 101 can include a memory for storing application data.

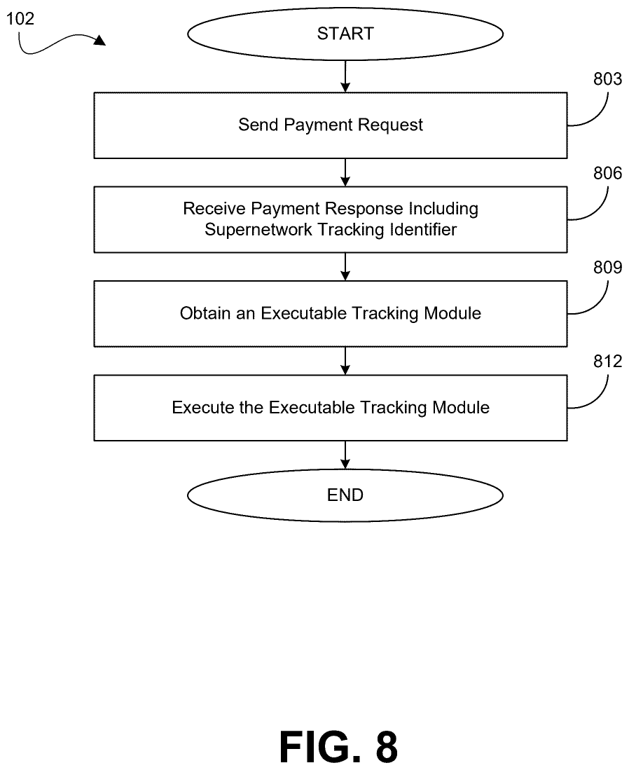

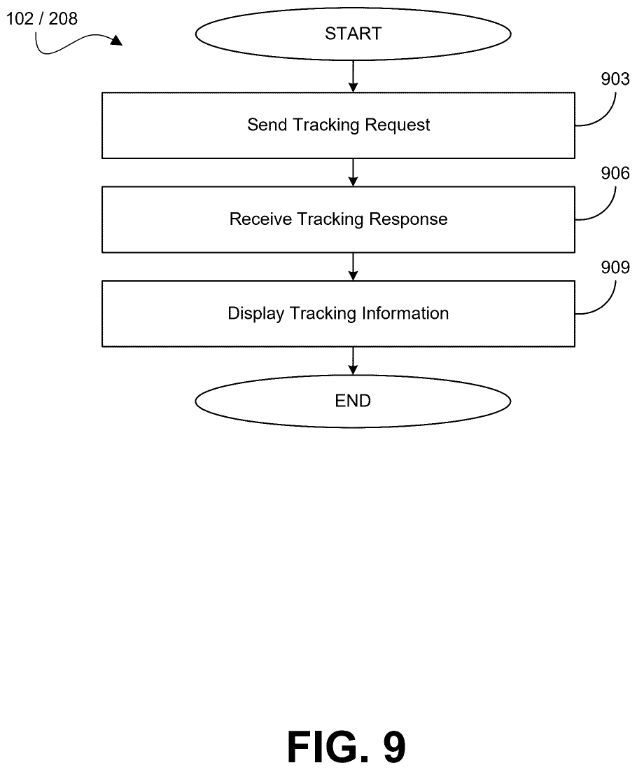

A client device 101 can be configured to execute various applications such as a client application 102 or other applications. The client application 102 can be executed in a client device 101 to send a payment request, receive a payment response including a supernetwork tracking identifier, obtain an executable tracking module, and execute the executable tracking module. The client application 102 can also be executed to send a tracking request, receive a tracking response, and display tracking information. Additional information regarding the execution of the client application 102 will be further described in the discussion of FIG. 8 and FIG. 9.

Participant systems 103 represent systems owned or operated by members of the payment network 100, such as banks or other financial institutions that use the payment network 100 to send and receive payments. The network hub 106 can represent one or more computing systems and software services that receive and reconcile payment requests from participant systems 103.

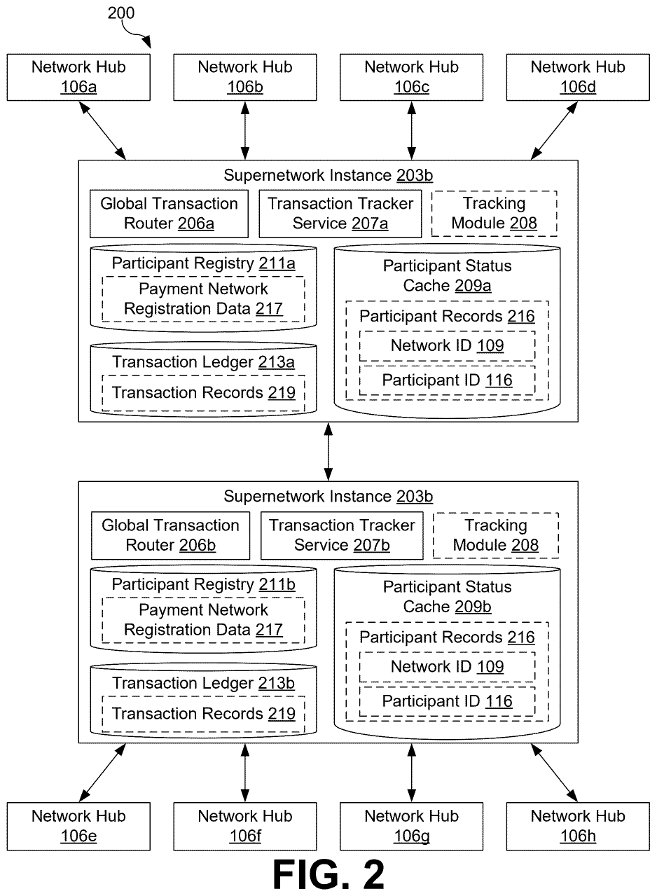

Accordingly, the network hub 106 can store various data to allow it to facilitate payments from one network participant 103 to another network participant 103, as well as route payments from a network participant 103 of the payment network 100 to another network participant 103 of another payment network 100 using a supernetwork 200 (FIG. 2). This data could include a network identifier 109 and one or more participant accounts 113.

The network identifier 109 can represent any identifier that uniquely identifies a payment network 100 with respect to another payment network 100. The network identifier 109 can be used by the supernetwork 200 to identify or distinguish between individual payment networks 100 when routing payments between payment networks 100.

Participant accounts 113 can be used by the network hub 106 to track the amount of funds each participant system 103 has on deposit with the payment network 100. Accordingly, each participant system 103 of a participant can be associated with a participant account 113. A participant account 113 can include information such as a participant identifier 116 and a balance 119. The participant identifier 116 can be any identifier that uniquely identifies a participant system 103, and therefore a participant, with respect to another participant system 103, and therefore another participant. The balance 119 can represent the amount of funds available in the participant account 113 to a respective participant. When a payment request is sent by a first participant system 103, the amount of the balance 119 in the participant account 113 associated with the first participant system 103 is reduced by the amount specified in the payment request. Meanwhile, the amount of the balance 119 in the participant account 113 of the second, recipient participant system 103 is increased by the amount specified in the payment request.

Moreover, an operator of the supernetwork 200 can also maintain a participant account 113 with the payment network 100. The participant account 113 of the supernetwork 200 can be used by the supernetwork 200 to facilitate payments between members of the payment network 100 and members of other payment networks 100, as described in further detail later.

FIG. 2 is a schematic block diagram depicting an example of a supernetwork 200 according to various embodiments of the present disclosure. The supernetwork 200 can be implemented to route payments between different payment networks 100 (FIG. 1), thereby allowing a participant of a first payment network 100 to make a payment to a participant of a separate, second payment network 100. Accordingly, the supernetwork 200 can include one or more supernetwork instances 203, such as supernetwork instance 203a and supernetwork instance 203b, that form a peer-to-peer network with each other. Each supernetwork instance 203 can be in data communication with one or more network hubs 106, such as network hubs 106a, 106b, 106c, 106, 106e, 106f, 106g, and 106h.

Each supernetwork instance 203 can include a number of components. For example, a super network instance 203 can include a global transaction router 206, a transaction tracker service 207, a tracking module 208, a participant status cache 209, a participant registry 211, and a transaction ledger 213. The global transaction router 206 can be executed to route payment requests between network hubs 106 of different payment networks 100 connected to a supernetwork instance 203. The transaction tracker service 207 can be executed to assign unique, one-time identifiers to identify transactions that are made across the different payment networks 100 and provide status updates to client devices.

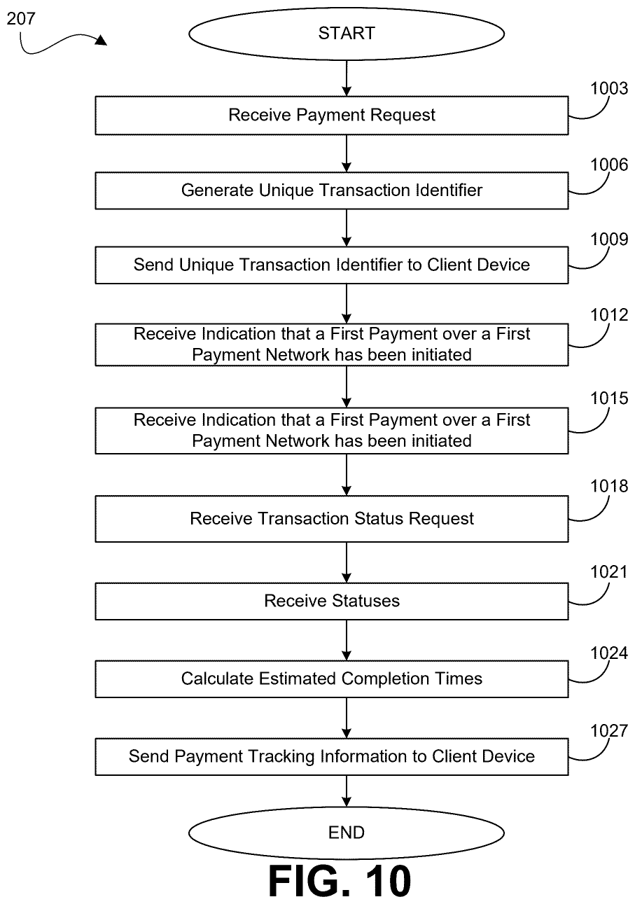

The transaction tracker service 207 can be executed to perform various actions. For example, the transaction tracker service 207 can be executed to receive a payment request, generate a unique transaction identifier, send the unique transaction identifier to a client device 101. The transaction tracker service 207 can also obtain statuses from a payment network 100 or a network hub 106, calculate an estimated completion time to finish a transfer of funds over the payment network 100 or a network hub 106, and send payment tracking information to a client device 101. Additional information regarding the execution of the transaction tracker service 207 will be further described in the discussion of FIG. 10.

The tracking module 208 can be stored on a supernetwork instance 203, but can be downloaded and executed by a client device 101 or a client application 102 on a client device 101. The tracking module 208 can be represented as computer executable code or interpreted code which can be executed by the client device 101. In at least one embodiment, the tracking module 208 can be a JavaScript script that can be executed by a client device 101. The tracking module 208 can be executed to send a tracking request, receive a tracking response, and display tracking information.

The participant status cache 209, participant registry 211, and the transaction ledger 213 are all representative of data stores and associated with the operation of the various applications or functional entities of the various embodiments of the present disclosure. The participant status cache 209, participant registry 211, and the transaction ledger 213 can be implemented as relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. In many instances of the present disclosure, participant status cache 209, participant registry 211, and the transaction ledger 213 can be implemented as distributed, eventually consistent data stores in order to synchronize the data across multiple supernetwork instances 203. The participant status cache 209 can include one or more participant records 216. The participant registry 211 can store payment network registration data 217. Meanwhile the transaction ledger 213 can include one or more transaction records 219. Other data can also be stored in the participant status cache 209, participant registry 211, or the transaction ledger 213 as desired by various embodiments of the present disclosure. Moreover, while depicted separately, the data stored in the participant status cache 209, participant registry 211, and the transaction ledger 213 can be combined into one or more data stores in some implementations.

A participant record 216 represents a record of a participant system 103 that is a member of a payment network 100. Each participant record 216 can include the network identifier 109 of the payment network 100 that the participant system 103 is a member of, as well as the participant identifier 116 of the participant system 103 in the payment network 100. If a participant or participant system 103 is a member of or participant in multiple payment networks 100, then the participant or participant system 103 could be associated with multiple participant records 216. Other information can also be included in a participant record 216 as desired for particular implementations of the present disclosure.

Payment network registration data 217 includes information about individual payment networks 100 with a network hub 106 connected to a supernetwork instance 203 of the supernetwork. Payment network registration data 217 can include a list of network hubs 106 or payment networks 100 and the individual supernetwork instances 203 that the network hubs 106 are connect to or in data communication with. For example, payment network registration data 217 could map a network identifier 109 for a payment network 100 to a particular supernetwork instance 203 (e.g., by using an instance identifier of the supernetwork instance 203). Other information regarding individual payment networks 100 could also be stored in the payment network registration data 217 as desired for individual implementations of the present disclosure.

A transaction record 219 can represent a record of a transaction made between participants of two different payment networks 100 within the supernetwork 200. Information stored in the transaction record 219 can include the participant identifier 116 and network identifier 109 of the payer, the participant identifier 116 and network identifier 109 of the payee, the amount of the transaction, as well as any other information that may be relevant to a particular embodiment of the present disclosure.

Next, a general description of the operation of the various components of the supernetwork 200 is provided. Although the following description provides merely an example of the operation of the supernetwork 200, and the interactions between individual components, other interactions and operations can also be performed by the various embodiments of the present disclosure.

To begin, a network hub 106 of a payment network 100 can be configured to connect to a supernetwork instance 203 of the supernetwork 200. As part of the connection process, the network hub 106 can be configured to send and receive message to the supernetwork instance 203 using a supernetwork compliant message protocol. The network hub 106 could also be configured to translate payment messages from the format of the payment network 100 serviced by the network hub 106 to the supernetwork compliant message protocol, and vice versa. Moreover, during the registration or first connection of the network hub 106 of the payment network 100 with the supernetwork instance 203, the payment network registration data 217 for the payment network 100 could be saved to the participant registry 211. For example, the network identifier 109 for the payment network 100 could be saved in association with an instance identifier of the supernetwork instance 203 that the network hub 106 is connected to. The participant registry 211 could then replicate, distribute, or synchronize the payment network registration data 217 with other participant registries 211 of other supernetwork instances 203.

Subsequently, the network hub 106 could provide a list of all participants in the payment network 100 of the network hub 106 to the global transaction router 206 of the supernetwork instance 203. This could include the network identifier 109 of the payment network 100 of the network hub 106, as well as the participant identifiers 116 of the participant systems 103 of the payment network 100 of the network hub 106. In response, the global transaction router 206 could create and save a participant record 216 for each of the participants of the payment network 100 of the network hub 106 to the participant status cache 209. The participant status cache 209 could then replicate, distribute, or synchronize the newly created participant records 216 to other participant status caches 209 of other supernetwork instances 203.

Later, a network hub 106 of a first payment network 100 (e.g., network hub 106a) could receive a payment request from a participant system 103 to send a payment to a second participant system 103 that is part of a second payment network 100 that uses a second network hub 106 (e.g., network hub 106h). The first network hub 106a could determine that the recipient of the transaction is not a member of the first payment network 100. In response, the first network hub 106a could create and send a payment request to the global transaction router 206a executed by the supernetwork instance 203a that the network hub 106a is connected to.

The global transaction router 206a could evaluate the payment request to determine where to route the payment request. For example, the global transaction router 206a could query the participant status cache 209a to determine whether there is a participant record 216 matching a participant identifier 116 for the recipient. If a participant record 216 exists, the global transaction router 206a could retrieve the network identifier 109 to determine which network hub 106 to route the payment request to. If the network identifier 109 fails to match the network identifier 109 of a network hub 106 connected to the supernetwork instance 203a, then the global transaction router 206a could query the payment network registration data 217 in the participant registry 211a to determine which supernetwork instance 203 (e.g., supernetwork instance 203b) the payment request should be routed to. The global transaction router 206a could then send the payment request to the appropriate global transaction router 206b.

The global transaction router 206b can receive the payment request and evaluate it to determine which network hub 106 to route the payment request to. For example, the global transaction router 206b could compare the network identifier 109 specified in the payment request to the network identifiers 109 of the network hubs 106 connected to the supernetwork instance 203b. If the network identifier 109 in the payment request matches the network identifier 106 of a connected network hub 106, such as network hub 106h, then the global transaction router 206b could forward the payment request to the recipient network hub 106h.

The transaction status service 207 can assign the payment request a unique transaction identifier and send the unique transaction identifier to the client device 101. Using the unique transaction identifier, the client device 101 can request the transaction status information for the payment request. The transaction status service 207 can request the payment status from the network hubs 106 for which the transactions are being performed. Based on the current statuses, the transaction status service 207 can calculate estimated completion times for the overall payment request and each individual transaction. Both the statuses and the estimated completion times can be sent as transaction status information to the client device 101, which can be rendered in a user interface.

The recipient network hub 106h could return a response message, which either accepts or rejects the payment request, to the global transaction router 206b. The global transaction router 206b could then relay the response message to the global transaction router 206a, and the global transaction router 206a could relay the response message to the source network hub 106a.

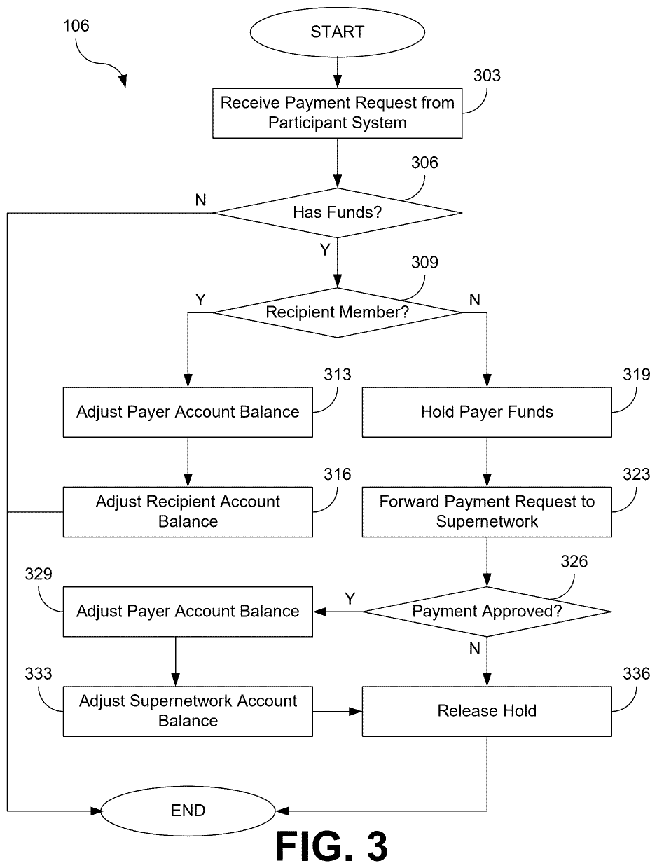

Referring next to FIG. 3, shown is a flowchart that provides one example of the operation of a portion of a network hub 106. The flowchart of FIG. 3 provides merely an example of the many different types of functional arrangements that can be employed to implement the operation of the depicted portion of the network hub 106. As an alternative, the flowchart of FIG. 3 can be viewed as depicting an example of elements of a method implemented within the payment network 100 or the supernetwork 200.

Beginning with block 303, the network hub 106 can receive a payment request from a participant system 103. The payment request can include information such as the participant identifier 116 of the recipient, the participant identifier 116 of the payee, the amount of the payment, and potentially other information.

Then, at block 306, the network hub 106 can determine whether the balance 119 of the participant account 113 associated with the participant identifier 116 of the payee that submitted the payment request at block 303 has sufficient funds to settle the payment. If the balance 119 of the participant account 113 has insufficient funds to settle the payment, then the process can end. Optionally, the network hub 106 could send a rejection or error message to the participant system that submitted the payment request. However, if the balance 119 of the participant account 113 has sufficient funds, then the process can proceed to block 309.

Moving on to block 309, the network hub 106 can determine if the recipient identified in the payment request is a participant in the payment network 100. For example, the network hub 106 could search for a participant account 113 with a participant identifier 116 matching the participant identifier 116 specified in the payment request. If matching participant account 113 is found, then the network hub 106 can determine that the recipient is member of the payment network 100 and the process can proceed to block 313. However, if a matching participant account 113 is not found, then this would indicate that the recipient is not a member of the payment network 100. In this situation, the process could proceed to block 319.

If the process proceeds to block 313, the network hub 106 can adjust the account balance 119 of the participant account 113 of the payer. For example, the network hub 106 could deduct an amount of funds from the account balance 119 equal to the amount of funds specified in the payment request.

Next, at block 316, the network hub 106, can similarly adjust the account balance 119 of the participant account 113 of the recipient. For example, the network hub 106 could add an amount of funds to the account balance 119 of the recipient equal to the amount of funds specified in the payment request.

However, if the process instead proceeds to block 319, the network hub 106 can place a hold on the account balance 119 of the participant account 113 of the payer that submitted the payment request at block 303. This hold can be done to prevent double-spending of funds held in the participant account 113 of the payer while the network hub 106 forwards the payment request to a global transaction router 206 of a supernetwork instance 203

Then, at block 323, the network hub 106 can forward the payment request to the global transaction router 206 of the supernetwork instance 203 that the network hub 106 is connect to. In some implementations, the network hub 106 could create a new payment message or payment request that satisfies any protocol requirements of the supernetwork 200. Generally, such a new payment message or payment request would include at least the same information that is included in the original payment, but be formatted in a standardized way that could be processed by the global transaction router 206.

Moving on to block 326, the network hub 106 can wait until it receives a payment response message from the global transaction router 206 of the supernetwork instance 203 that the network hub 106 is connected to. Once the payment response message is received, the network hub 106 can analyze the payment response message to determine if the payment request was accepted by the recipient network hub 106 or if the payment request was rejected. If the payment response message indicates that the payment request was accepted, then the process can proceed to block 329. However, if the payment response message indicates that the payment request was rejected, then the process can skip to block 336.

If the process proceeds to block 329, the network hub 106 can adjust the payer account balance 119. For example, the network hub 106 could deduct an amount of funds from the account balance 119 equal to the amount specified in the payment request. In some instances, the payment response message could include additional transaction fees (e.g., transaction fees required by the supernetwork 200 or the recipient network hub 106 to process the payment). In these instances, the additional transaction fees could also be deducted from the account balance 119 of the participant account 113 of the payer.

Next, at block 333, the network hub 106 can adjust the account balance 119 of a participant account 113 associated with the operator of the supernetwork 200. For example, the network hub 106 could add an amount of funds equal to the amount specified in the payment request and any additional transaction fees to the account balance 119 of the participant account 113 of the supernetwork 200.

Once the process proceeds to block 336, the network hub 106 can release the hold on the account balance 119 of the participant account 113 of the payee. Then, the process could end.

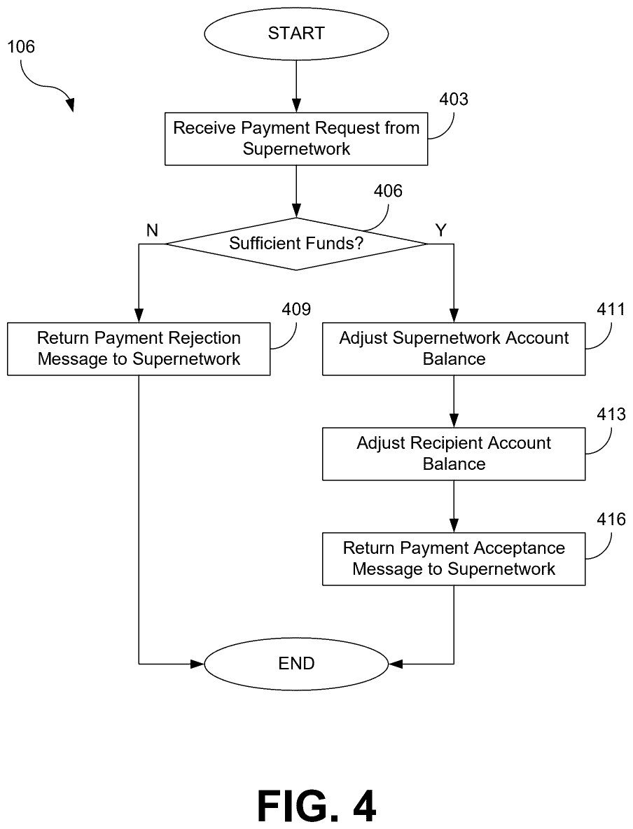

Referring next to FIG. 4, shown is a flowchart that provides one example of the operation of a portion of a network hub 106. The flowchart of FIG. 4 provides merely an example of the many different types of functional arrangements that can be employed to implement the operation of the depicted portion of the network hub 106. As an alternative, the flowchart of FIG. 4 can be viewed as depicting an example of elements of a method implemented within the payment network 100 or the supernetwork 200.

Beginning with block 403, a network hub 106 can receive a payment request from a global transaction router 206 of a supernetwork instance 203 connected to the network hub 106. For example, if a first network hub 106a forwarded a payment request to the global transaction router 206a using the process described in FIG. 3, then a recipient network hub 106 (e.g., network hub 106h) could receive a corresponding payment request from the global transaction router 206b of the supernetwork instance 203b.

Then, at block 406, the network hub 106 can determine whether the account balance 119 of the participant account 113 associated with the operator of the supernetwork 200 has sufficient funds to complete the transaction. If there are insufficient funds (e.g., because the payment request is larger than the current account balance 119 of the supernetwork 200 within the payment network 100), then the process can proceed to block 409. However, if there are sufficient funds to complete the payment request, then the process can proceed to block 411.

If the process proceeds to block 409, then the network hub 106 can generate a payment rejection message and return the payment rejection message to the global transaction router 206 of the supernetwork instance 203 that the network hub 106 is connected to. The payment rejection message can include the participant identifier 116 of the source of the payment and, potentially, the network identifier 109 of the source of the payment. In some instances, the payment rejection message could include a reason why the payment was rejected, while in other instances the reason for the rejection of the payment request could be omitted.

However, if the process proceeds to block 413, then the network hub 106 can adjust the account balance 119 of a participant account 113 associated with the operator of the supernetwork 200. For example, the network hub 106 could deduct an amount of funds equal to the amount specified in the payment request. The network hub 106 could also deduct any additional transaction fees from the account balance 119 of the participant account 113 of the operator of the supernetwork 200 to compensate the payment network 100 operator for the costs of processing the transaction.

Next, at block 413, the network hub 106 can adjust the account balance 119 of the participant account 113 of the recipient. Accordingly, the network hub 106 could search for the participant account 113 matching the participant identifier 116 specified in the payment request. The network hub 106 could then add an amount of funds to the account balance 119 of the matching participant account 113 equal to the amount specified in the payment request.

Subsequently, at block 416, the network hub 106 could generate and return a payment acceptance message to the global transaction router 206 of the supernetwork instance 203 that the network hub 106 is connected to. The payment acceptance message could include information such as a confirmation code or number, a confirmation of the amount deposited to the account balance 119 of the recipient, a timestamp indicating the time at which the recipient received the funds, the participant identifier 116 of the source of the payment and, potentially, the network identifier 109 of the source of the payment, as well as other information. The process can then subsequently end.

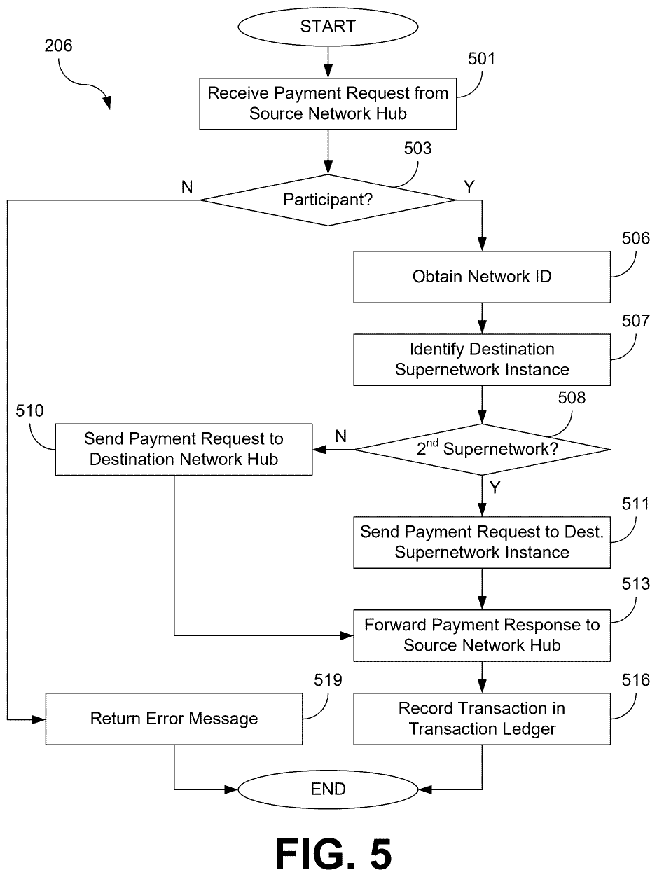

Referring next to FIG. 5, shown is a flowchart that provides one example of the operation of a portion of the global transaction router 206. The flowchart of FIG. 5 provides merely an example of the many different types of functional arrangements that can be employed to implement the operation of the depicted portion of the global transaction router 206. As an alternative, the flowchart of FIG. 5 can be viewed as depicting an example of elements of a method implemented within the supernetwork 200.

Beginning with block 501, the global transaction router 206 can receive a payment request from a source network hub 106. For example, the payment request could have been received as part of the process performed by the source network hub 106 at block 323. The payment request can include information such as the network identifier 109 and participant identifier 116 of the participant making the payment, the participant identifier 116 of the recipient, the network identifier 109 of the participant (if known), the amount of the payment, and potentially other information depending on the particular implementation of the present disclosure.

Moving on to block 503, the global transaction router 206 can determine whether the recipient of the payment request is a participant of an payment network 100 with a network hub 106 connected to a supernetwork instance 203 of the supernetwork 200. This would network hub 106 would be the destination network hub 106 for the payment request. For example, the global transaction router 206 could search the participant status cache 209 to identify a participant record 216 with a matching participant identifier 116. If a participant record 216 exists, then the process can proceed to block 506. If no participant record 216 exists, then the process can instead skip to block 516.

Then, at block 506, the global transaction router 206 can obtain the network identifier 109 for the destination network hub 106 from the participant record 216 identified at block 503.

Next, at block 507, the global transaction router 206 can identify the supernetwork instance 203 which the destination network hub 106 associated with the destination network identifier 109 obtained at block 506 is connected to. For example, the global transaction router 206 could search the payment registration data 217 in the participant registry 211 to identify the supernetwork instance 203 that is associated with the network identifier 109. However, in some implementations, the global transaction router 206 could cache a list of network hubs 106 that it is connected to, in which case the global transaction router 206 could query its cache instead of the participant cache registry 211.

Proceeding to block 508, the global transaction router 206 can determine whether the destination network hub 106 for the payment request is connected to the supernetwork instance 203 (e.g., supernetwork instance 203a) hosting the global transaction router 206, or is connected to a second supernetwork instance 203 (e.g., supernetwork instance 203b). This can be done by determining whether supernetwork instance 203 identified at block 507 is the same supernetwork instance 203 hosting the global transaction router 206. If the destination network hub 106 is connected to the same supernetwork instance 203 that is hosting the global transaction router 206, then the process can proceed to block 510. However, if the destination network hub 106 is connected to a second supernetwork instance 203, then the process can proceed to block 511.

If the process proceeds to block 510, the global transaction router 206 can send the payment request to the destination network hub 106 that is connected to the supernetwork instance 203 hosting the global transaction router 206. The global transaction router 206 can then wait to receive a response from the destination network hub 106 regarding the payment status.

However, if the process proceeds to block 511, the global transaction router 206 can send the payment request to the global transaction router 206 hosted by the supernetwork instance 203 identified at block 509. The global transaction router 206 can then wait to receive a response from the second global transaction router 206 regarding the payment status.

Later, at block 513, the global transaction router 206 can receive a payment response indicating the status of the payment request and return or forward it to the source network hub 106. For example, the global transaction router 206 could search the participant status cache 209 to identify a participant record 216 with a matching participant identifier 116. The global transaction router 206 could then determine the network identifier 109 for the destination of the message and determine that the network identifier 109 is for a network hub 106 (e.g., the source network hub 106) connected to the supernetwork instance 203 hosting the global transaction router 206. For example, the global transaction router 206 could query the payment registration data in participant cache registry 211 to determine that the destination network hub 106 is connected to the global transaction router 206. However, in some implementations, the global transaction router 206 could cache a list of network hubs 106 that it is connected to, in which case the global transaction router 206 could query its cache instead of the participant cache registry 211. The global transaction router 206 can also cache or temporarily store the payment response for use at block 516.

Then, at block 516, the global transaction router 206 store or record the transaction in the transaction ledger 213. For example, if the payment response received at block 513 were a payment acceptance message, then the global transaction router 206 could record a transaction record 219 in the transaction ledger 213 containing information such as a confirmation code or number, a confirmation of the amount deposited to the account balance 119 of the recipient, a timestamp indicating the time at which the recipient received the funds, the participant identifier 116 of the source of the payment and, potentially, the network identifier 109 of the source of the payment, as well as other information. Likewise, if the payment response were a payment rejection message, then the global transaction router 206 could record a transaction record 219 in the transaction ledger 213 containing the participant identifier 116 of the source of the payment and, potentially, the network identifier 109 of the source of the payment. In some instances, the payment rejection message could include a reason why the payment was rejected, in which case the reason for the rejection could also be included in the transaction record 219. The process could then end.

If the process proceeds to block 519, the global transaction router 206 can generate and return an error message to the source network hub 106 indicating that the payment request could not be completed. In some implementations, the error message could include an indication of the problem (e.g., destination is not a member of a supported payment network 100, the supernetwork has insufficient funds at the destination, etc.). Once the error message is sent, the process can end.

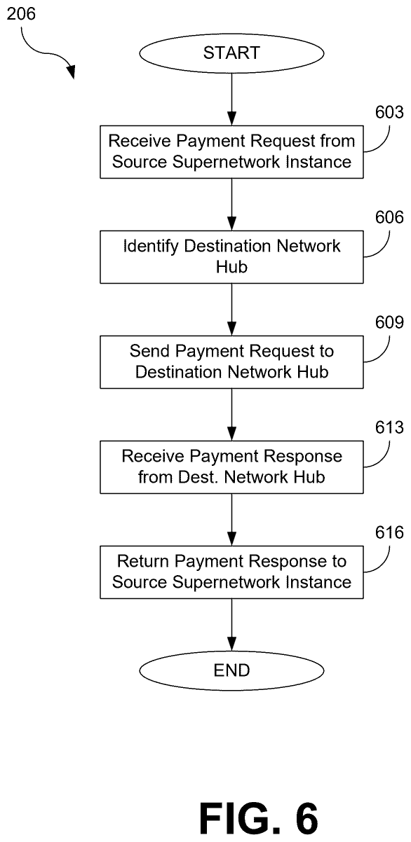

Referring next to FIG. 6, shown is a flowchart that provides one example of the operation of a portion of the global transaction router 206. The flowchart of FIG. 6 provides merely an example of the many different types of functional arrangements that can be employed to implement the operation of the depicted portion of the global transaction router 206. As an alternative, the flowchart of FIG. 6 can be viewed as depicting an example of elements of a method implemented within the supernetwork 200.

Beginning with block 603, the global transaction router 206 (e.g., global transaction router 206b) of a second supernetwork instance (e.g., supernetwork instance 203b) can receive a payment request from a first global transaction router 206 (e.g., global transaction router 206a) hosted or executed by a first supernetwork instance (e.g., supernetwork instance 203a). The payment request could be received as a result of the first global transaction router 206 determining that the second global transaction router 206 has a connection to the network hub 106 of the recipient of the payment. An example of this process has been previously discussed and illustrated by FIG. 5.

Then, at block 606, the global transaction router 206 identify the destination network hub 106. For example, the global transaction router 206 could analyze the payment request to determine the participant identifier 116 of the recipient. The global transaction router 206 could then query the participant status cache to search for a participant record 216 with a matching participant identifier 116. The global transaction router 206 could then retrieve the network identifier 109 from the participant record 216. The global transaction router 206 could then query the payment network registration data 217 in participant cache registry 211 to determine that the destination network hub 106 is connected to the global transaction router 206. However, in some instances, the global transaction router 206 could cache a list of network hubs 106 that it is connected to, in which case the global transaction router 206 could query its cache instead of the participant cache registry 211.

Next, at block 609, the global transaction router 206 could then forward or otherwise send the payment request received at block 603 to the network hub 106 identified at block 606.

Moving on to block 613, the global transaction router 206 can receive a payment response from the destination network hub 106 that the payment request was forwarded to at block 609. The payment response, as previously discussed, could be a payment acceptance, a payment rejection, or other payment status message.

Subsequently, at block 616, the global transaction router 206 can return the payment response received at block 613 to the source supernetwork instance 203 from which the payment request was received at block 603. For example, the global transaction router 206 could search the participant status cache 209 to identify a participant record 216 with a matching participant identifier 116 specifying the source of the payment and, therefore, the destination for the payment response. The global transaction router 206 could obtain the network identifier 109 from the identified participant record 216. This could be skipped, however, in those instances where the payment response included the network identifier 109 identifying the destination of the payment response. The global transaction router 206 could then search the payment network registration data 217 in the participant registry 211 to identify the supernetwork instance 203 that is associated with the network identifier 109, and forward the payment response to the identified supernetwork instance 203. The process can subsequently end.

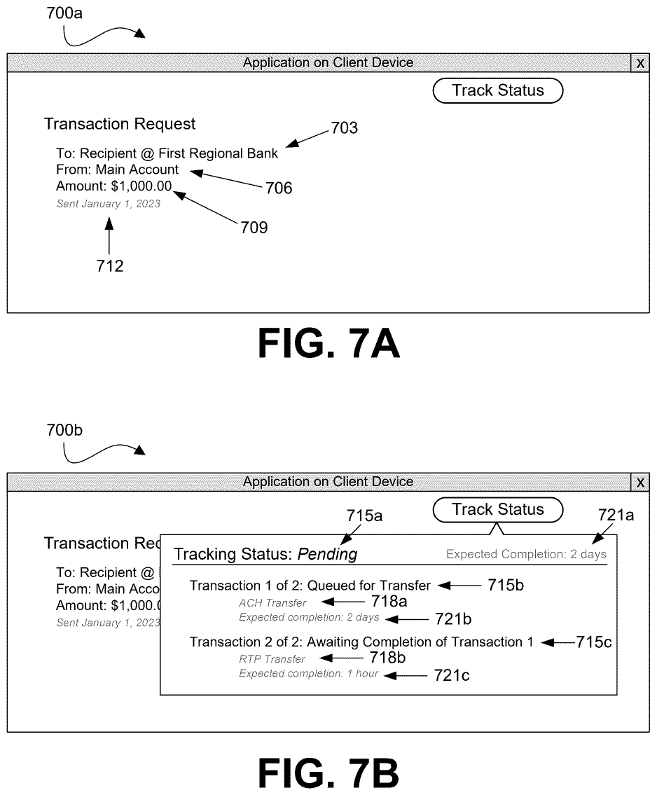

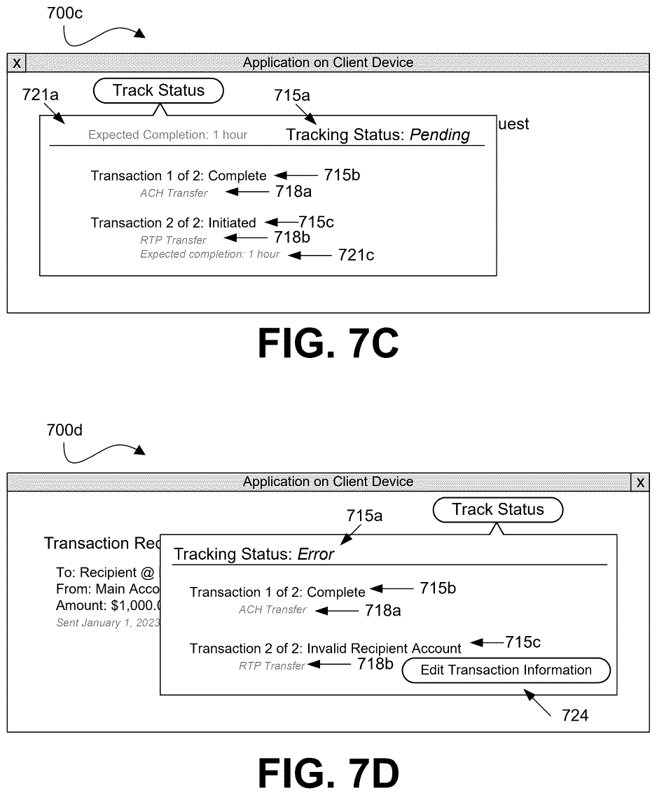

FIGS. 7A-7D depict various examples of a user interface 700 (shows as user interface 700a, user interface 700b, user interface 700c, and user interface 700d) that can be rendered on a client device 101. FIG. 7A depicts an example of a user interface 700a that depicts visual example of a transaction request that a sender has sent to participant system 103, which can be sent to a network hub 106 and further sent to a supernetwork instance 203. The transaction request includes a recipient identifier 703, a sender account identifier 706, an amount 709, and a transaction request sent date 712.

Referring next to FIG. 7B, the user interface 700b can display the transaction status information of the transaction request made in FIG. 7A. For instance, the transaction status information can include tracking statuses 715 (e.g., an overall tracking status 715a, a first payment tracking status 715b, and a second payment tracking status 715c, etc.), the payment network types 718 (e.g., a first payment network type 718a and a second payment network type 718b, etc.), and an expected completion dates and/or times 721 (e.g., an overall expected completion date and/or time 721a, a first payment expected completion date and/or time 721b, and a second payment expected completion date and/or time 721c, etc.).

The tracking statuses 715 can be various values based on the payment network type 718. For example, ACH statuses can include communicating, declined, pending origination, voided, originating, settled, originated, charged back, and/or other statuses. In at least another example, RTP statuses can include rejected, account blocked, transaction exceeds limits, information missing, transaction not supported, or other statuses. The user interface 700b could use alternative language to the previous examples to present more user-friendly language. The payment network types 718 can include real-time payment (RTP) network, Automated Clearing House network (ACH), the Society for Worldwide Interbank Financial Telecommunication (SWIFT) network, Single Euro Payments Area (SEPA), Blockchains (e.g., Bitcoin Network, Ethereum Network, etc.), checking and eChecking networks, card networks, and other type of networks to exchange, process, and/or transfer currency.

The expected completion dates and/or times 721 can be represented as any period of time or as a specific date or time. For example, the expected completion dates and/or times 721 can be minutes, hours, second, days, weeks, and/or months. In at least another embodiment, the expected completion date and/or time 721 could be a specific date (e.g., Jan. 15, 2023, etc.). In at least some embodiments, a user interface 700b could display both a period of time and a specific date and/or time.

The user interface 700c of FIG. 7C represents the user interface 700b of FIG. 7B including updated tracking status information. For instance, the first payment tracking status 715b has been updated to a “complete” status. Additionally, the second payment tracking status 715c has been updated to an “initiated” status. Because the first of the two transactions has been completed, the expected completion time is now based solely on the second transaction, as shown in the overall expected completion date and/or time 721a and the second payment expected completion date and/or time 721c.

The user interface 700d of FIG. 7D represents the user interface 700c of FIG. 7C including further updated tracking status information. For instance, the overall payment tracking status 715a and the second payment tracking status 715c have been updated to show than an error has occurred in the second transaction, so the overall tracking status also shows that an error has occurred. In some embodiments, the user interface 700d can include an affordance to allow a user to edit the transaction information and re-attempt to perform a transaction. For example, the user interface 700d can include an edit transaction information button 724.

Referring next to FIG. 8, shown is a flowchart that provides one example of the operation of a portion of the client application 102. The flowchart of FIG. 8 provides merely an example of the many different types of functional arrangements that can be employed to implement the operation of the depicted portion of the client application 102. As an alternative, the flowchart of FIG. 8 can be viewed as depicting an example of elements of a method implemented within the network environment 100.

Starting with block 803, the client application 102 can send a payment request to a participant system 103. The payment request can be representative of an authorization from a user to pay a specified amount to an account of another user. In at least some embodiments, the account of another user can be otherwise directly unobtainable over the network hub 106 of the sender's payment account. The participant system 103 can further send the request to a network hub 106, which can then further send the request to a supernetwork instance 203. As previously discussed, a supernetwork instance 203 can be connected to various payment networks 100 via respective network hubs 106, which can be used to process a transaction. In at least one embodiment, the payment request can specify at least an identifier for a recipient institution and/or an amount for the payment request. In at least some embodiments, the payment request can also include an identifier representing the sending account. The payment request can include information such as the network identifier 109 and participant identifier 116 of the participant making the payment, the participant identifier 116 of the recipient, the network identifier 109 of the participant (if known), the amount of the payment, and potentially other information depending on the particular implementation of the present disclosure.

Next, at block 806, the client application 102 can receive a payment response including a supernetwork tracking identifier. A supernetwork tracking identifier can represent a unique identifier that represents the entirety of the transaction requested in the payment request of block 803. The supernetwork tracking identifier can take the form of an alphanumerical value. In at least some embodiments, the supernetwork tracking identifier can be a unique uniform resource locator (URL) which uniquely identifies the transaction. In at least some embodiments, the payment response can also include an indication that the payment request is being or was forwarded to a global transaction router 206 of the supernetwork instance 203.

In some embodiments, the payment response can include information about how the global transaction router 206 will split the transaction into its various steps (e.g., a first payment, a second payment, etc.). In at least some embodiments, the payment response can indicate that a first payment and a second payment will be performed concurrently, meaning the first payment and the second payment are initiated at roughly the same time, such that the first payment has not completed by the time the second payment has initiated. In at least another embodiment, the payment response can indicate that a first payment and a second payment will be performed sequentially, meaning the first payment must first be completed before the second payment is initiated. In at least some embodiments, the process of FIG. 8 can end after block 806. In at least another embodiment, the process FIG. 8 can continue to block 903 of FIG. 9. In at least some embodiments, the process FIG. 8 can continue to block 809.

Next, at block 809, the client application 102 can obtain an executable tracking module 208. The tracking module 208 can be represented as computer executable code or interpreted code which can be executed by the client device 101. In at least one embodiment, the tracking module 208 can be a JavaScript script that can be executed by a client device 101. The tracking module 208 can be executed to send a tracking request, receive a tracking response, and display tracking information. In at least some embodiments, the tracking module 208, when executed by the computing device 101, can perform the process of FIG. 9. Next, at block 812, the client application 102 can cause the computing device 101 to execute the tracking module. In such an embodiment, the tracking module 208 can perform the process of FIG. 9. Once the execution of block 812 has been performed, the process of FIG. 8 can end.

Referring next to FIG. 9, shown is a flowchart that provides one example of the operation of a portion of the client application 102. In at least another embodiment, the flowchart provides an example of the operation of a portion of the tracking module 208. The flowchart of FIG. 9 provides merely an example of the many different types of functional arrangements that can be employed to implement the operation of the depicted portion of the client application 102 or the tracking module 208. As an alternative, the flowchart of FIG. 9 can be viewed as depicting an example of elements of a method implemented within the network environment 100.

Starting with block 903, the client application 102 or the tracking module 208 can send a tracking request to a transaction tracker service 207 of the supernetwork instance 203. The tracking request represents a request to obtain tracking information about a previously made payment request (e.g., the payment request of block 803 in FIG. 8, etc.). The tracking request can include the supernetwork tracking identifier, as well as various other information. In at least one embodiment where the supernetwork tracking identifier can be a URL, the tracking request can be sent to the URL. In at least another embodiment, the tracking module 208 can include a destination URL for which to send the supernetwork tracking identifier, such that the response would provide payment tracking information.

Next, at block 906, the client application 102 or the tracking module 208 can receive a tracking response to the tracking request. In at least some embodiments, the tracking response can include a first tracking status that corresponds to a first transfer of funds over the first payment network 100. In some embodiments, the tracking response can include a second tracking status that corresponds to a second transfer of funds over a second payment network 100. In some embodiments, the tracking response can include a first estimated date that represents a first expected date when the first transfer of funds over the first payment network 100 will be completed. In some embodiments, the first estimated date can be determined based at least one of the first payment network 100, a payment request date, and/or the first tracking status. In at least some embodiments, a second estimated date that represents a second expected date when the second transfer of funds over the second payment network 100 will be completed. In some embodiments, the second estimated date can be determined based at least on at least one of the first payment network 100, a payment request date, the first tracking status, the second payment network 100, and the second tracking status. Additional information about the estimated dates can be found in the discussion of block 1024 of FIG. 10. Various other information can be included in the tracking response.

Next, at block 909, the client application 102 or the tracking module 208 can display (or cause the client device 101 to render or display) a user interface including the payment tracking information. The displayed user interface can include any of the payment tracking information described in block 906. In at least some embodiments, the user interface can include at least the first tracking status, the second tracking status, and a date and time the tracking response was received. In at least another embodiment, the user interface can display an indication that at least one of the first transfer of funds or the second transfer of funds will be delayed due to a holiday. Once block 909 has been completed, the process of FIG. 9 can end.

Referring next to FIG. 10, shown is a flowchart that provides one example of the operation of a portion of the transaction tracking service 207. The flowchart of FIG. 10 provides merely an example of the many different types of functional arrangements that can be employed to implement the operation of the depicted portion of the transaction tracking service 207. As an alternative, the flowchart of FIG. 10 can be viewed as depicting an example of elements of a method implemented within the network environment 100.

Starting with block 1003, the transaction tracking service 207 can receive a payment request. In at least one embodiment, the payment request can be received from a source network hub 106, which could have received the payment request from a participant system 103, which could have received the request from a client device 101, as previously discussed. The payment request can include information such as the network identifier 109 and participant identifier 116 of the participant making the payment, the participant identifier 116 of the recipient, the network identifier 109 of the participant (if known), the amount of the payment, and potentially other information depending on the particular implementation of the present disclosure. Various other information can be received as well. As previously discussed, the global transaction router 206 can determine how to route the payment between one or more network hubs 106. In such a situation, the global transaction router 206 can determine how to ensure the funds are transferred from the sender over a first payment network 100 and a transferred to a recipient over a second payment network 100. Although this example describes two payments, it should be understood that embodiments can include various legs of the routing to ensure the funds are transferred from the sender to the recipient. In at least the discussion of FIG. 10, the global transaction router 206 can determine that the payment request requires at least two legs of the routing: a first routing leg over a first network (e.g., via network hub 106a, etc.) and a second routing leg over a second network (e.g., via network hub 106b, etc.).

Next, at block 1006, the transaction tracking service 207 can generate a unique transaction identifier that can correspond to the entirety of the payment request. In such an embodiment, the unique transaction identifier can correspond to both the first routing leg over the first payment network 100 (a transfer of funds over the payment network 100) and the second routing leg over the second payment network 100. A supernetwork tracking identifier can represent a unique identifier that represents the entirety of the transaction requested in the payment request of block 803. The supernetwork tracking identifier can take the form of an alphanumerical value. In at least some embodiments, the supernetwork tracking identifier can be a unique uniform resource locator (URL) which uniquely identifies the transaction. Once the transaction tracking service 207 has generated the unique transaction identifier, at block 1009, the transaction tracking service 207 can send the unique transaction identifier to the client device 101.

Next, at block 1012, the transaction tracking service 207 can receive a first indication that a first routing leg over the first payment network 100 has been determined. In at least one embodiment, the transaction tracking service 207 can receive the first indication from the global transaction router 206. The global transaction router 206 can be responsible for establishing routes among network hubs 106. In at least one embodiment, the first indication can include a status of the first transaction, which can be stored in the transaction records 219.

Next, at block 1015, the transaction tracking service 207 can receive a second indication that a second routing leg over the second payment network 100 has been determined. In at least one embodiment, the transaction tracking service 207 can receive the second indication from the global transaction router 206. The global transaction router 206 can be responsible for establishing routes among network hubs 106. In at least one embodiment, the second indication can include a status of the second transaction, which can be stored in the transaction records 219.

In at least one embodiment, the transaction tracking service 207 can determine that the first routing leg and the second routing leg are performed asynchronously, meaning the first routing leg and the second routing leg are initiated by their respective network hubs 106 at roughly the same time. For example, a first routing leg can be established over an ACH payment network and a second routing leg can be established over an RTP payment network. In such an example, the recipient could receive funds immediately due to the speed of the RTP payment network, despite the ACH payment network taking days to complete the transaction.

In at least another embodiment, the transaction tracking service 207 can determine that the first routing leg and the second routing are performed synchronously, meaning the first routing leg must be completed before the second routing leg is initiated. For example, a first routing leg can be established over an ACH payment network and a second routing leg can be established over an RTP payment network. In such an example, the payment over the second routing leg cannot be initiated by the second payment network 100 until the payment has been completed over the first routing leg.

Next, at block 1018, the transaction tracking service 207 can receive a transaction request from the client device 101. In many embodiments, the transaction request can be the transaction request sent from block 903 of FIG. 9. The tracking request can represent a request to obtain tracking information about a previously made payment request (e.g., the payment request of block 803 in FIG. 8, etc.). The tracking request can include the supernetwork tracking identifier, as well as various other information.

Next, at block 1021, the transaction tracking service 207 can receive transaction statuses. In at least some embodiments, the transaction tracking service 207 can receive a first status of the first routing leg from the first payment network 100 (or network hub 106). In at least some embodiments, the transaction tracking service 207 can receive a second status of the second routing leg from the second payment network 100 (or network hub 106). The tracking statuses can be various values based on the payment network type. For example, ACH statuses can include communicating, declined, pending origination, voided, originating, settled, originated, charged back, and/or other statuses. In at least another example, RTP statuses can include rejected, account blocked, transaction exceeds limits, information missing, transaction not supported, or other statuses. The user interface could use alternative language to the previous examples to present more user-friendly language. The payment network types can include real-time payment (RTP) network, Automated Clearing House network (ACH), The Society for Worldwide Interbank Financial Telecommunication (SWIFT) network, Single Euro Payments Area (SEPA), Blockchains (e.g., Bitcoin Network, Ethereum Network, etc.), checking and eChecking networks, card networks, and other type of networks to exchange, process, and/or transfer currency. In at least one embodiment, the statuses of the transactions be stored in the transaction records 219 for future reference.

Next, at block 1024, the transaction tracking service 207 can calculate estimated completion times. The transaction tracking service 207 can calculate the first estimated date based at least on the first payment network 100, a payment request date, and the first tracking status. The transaction tracking service 207 can use the payment request date as a starting date, and extend the estimated amount based on the first tracking status and the expected amount of time to complete portions of the transaction based on the payment network type (e.g., RTP, ACH, etc.). In at least some embodiments, the transaction tracking service 207 can calculate the second estimated date based at least on the first payment network 100, a payment request date, the first tracking status, the second payment network 100, and the second tracking status. In at least some embodiments, the transaction tracking service 207 can calculate the first estimated completion time that corresponds to the first routing leg over the first payment network 100 based at least on a first date and time the first routing leg over the first payment network 100 was initiated, the first payment network, and the first status. In at least some embodiments, the transaction tracking service 207 can calculate the second estimated completion time that corresponds to the second routing leg over the second payment network 100 based at least on a second date and time of the second routing leg over the second payment network 100 was initiated, the second payment network, and the second status.

Next, at block 1027, the transaction tracking service 207 can send payment tracking information to the client device 101. In at least some embodiments, the transaction tracking service 207 can send the first status and the second status to a client device. In at least some embodiments, the transaction tracking service 207 can also send a first estimated completion time and a second estimated completion time, as previously calculated in block 1024. In at least some embodiments, the transaction tracking service 207 can send the payment tracking information to the client device 101 in response to receiving the statuses, as previously discussed in block 1021. Once the payment tracking information has been sent to the client device, the process of FIG. 10 can end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
send a payment request to a network hub connected to a supernetwork instance and linked to a first payment network, the payment request specifying an identifier for a recipient institution and an amount of the payment request;
receive a payment response to the payment request indicating that the payment request is being forwarded to a global transaction router of the supernetwork instance, wherein the response to the payment request comprises at least a supernetwork tracking identifier;
send a tracking request to a transaction tracker service of the supernetwork instance, the tracking request comprising the supernetwork tracking identifier; and
receive a tracking response to the tracking request, the tracking response comprising at least:
a first tracking status that corresponds to a first transfer of funds over the first payment network; and
a second tracking status that corresponds to a second transfer of funds over a second payment network.

2. The system of claim 1, wherein the machine-readable instructions, when executed by the processor, further cause the computing device to at least display, by a user interface, at least the first tracking status, the second tracking status, and a date and time the tracking response was received.

3. The system of claim 2, wherein the machine-readable instructions that display by the user interface, when executed by the processor, further cause the computing device to display, by the user interface, an indication that at least one of the first transfer of funds or the second transfer of funds will be delayed due to a banking holiday.

4. The system of claim 1, wherein the tracking response further comprises at least:
a first estimated date that represents a first expected date when the first transfer of funds over the first payment network will be completed; and
a second estimated date that represents a second expected date when the second transfer of funds over the second payment network will be completed.

5. The system of claim 4, wherein the first transfer of funds over the first payment network and the second transfer of funds over the second payment network are performed concurrently.

6. The system of claim 4, wherein the first estimated date is determined based at least on the first payment network, a payment request date, and the first tracking status.

7. The system of claim 4, wherein the second estimated date is determined based at least on the first payment network, a payment request date, the first tracking status, the second payment network, and the second tracking status.

8. The system of claim 1, wherein at least one of the first payment network or the second payment network is an Automated Clearing House (ACH) network.

9. A method, comprising:
sending, by a computing device, a payment request to a network hub connected to a supernetwork instance and linked to a first payment network, the payment request specifying an identifier for a recipient institution and an amount of the payment request;
receiving, by the computing device, a payment response to the payment request indicating that the payment request is being forwarded to a global transaction router of the supernetwork instance, wherein the response to the payment request comprises at least a supernetwork tracking identifier;
obtaining, by the computing device, a tracking module configured to obtain and render tracking information for the supernetwork tracking identifier, wherein the tracking module is machine-readable code that can be executed by the computing device;
executing, by the computing device, the tracking module;
sending, by the tracking module on the computing device, a tracking request to a transaction tracker service of the supernetwork instance, the tracking request comprising the supernetwork tracking identifier; and
receiving, by the tracking module on the computing device, a tracking response to the tracking request, the tracking response comprising at least:
a first tracking status that corresponds to a first transfer of funds over the first payment network; and
a second tracking status that corresponds to a second transfer of funds over a second payment network.

10. The method of claim 9, further comprising rendering, by a user interface of the computing device, at least the first tracking status, the second tracking status, and a date and time the tracking response was received.

11. The method of claim 10, wherein the tracking module caused the user interface of the computing device to render at least the first tracking status, the second tracking status, and the date and time the tracking response was received.

12. The method of claim 9, wherein the first tracking status must indicate that the first transfer of funds over the first payment network is completed before the second transfer of funds over the second payment network can be performed.

13. The method of claim 9, wherein the tracking module is a JavaScript library that can be executed by an application on the computing device.

14. The method of claim 9, wherein at least one of the first payment network or the second payment network is a Real-Time Payment (RTP) network.

15. The method of claim 9, wherein at least one of the first payment network or the second payment network is a blockchain network.

16. A system, comprising:
a computing device comprising a processor and a memory; and
machine-readable instructions stored in the memory that, when executed by the processor, cause the computing device to at least:
receive a payment request from a source network hub connected to a supernetwork instance and linked to a first payment network, the payment request specifying an identifier for a recipient institution and an amount of the payment request;
receive a first indication that a first transfer of funds over the first payment network has been initiated;
receive a second indication that a second transfer of funds over the second payment network has been initiated;
receive a first status of the first transfer of funds;
receive a second status of the second transfer of funds; and
send, upon receiving the first status and the second status, the first status and the second status to a client device.

17. The system of claim 16, wherein the machine-readable instructions, when executed by the processor, further cause the computing device to at least:
generate a unique transaction identifier that corresponds to both the first transfer of funds over the first payment network and the second transfer of funds over the second payment network; and
send the unique transaction identifier to the client device.

18. The system of claim 17, wherein the machine-readable instructions that receive the first status of the first transfer of funds are executed in response to receiving a status request comprising the unique transaction identifier.

19. The system of claim 17, wherein the unique transaction identifier is a unique uniform resource locator (URL).

20. The system of claim 16, wherein:
the machine-readable instructions that send the first status and the second status to the client device, when executed by the processor, further sends a first estimated completion time and a second estimated completion time; and
the machine-readable instructions, when executed by the processor, further cause the computing device to at least:
calculate the first estimated completion time that corresponds to the first transfer of funds over the first payment network, wherein the first estimated completion time is calculated based at least on a first date and time the first transfer of funds over the first payment network was initiated, the first payment network, and the first status;
calculate the second estimated completion time that corresponds to the second transfer of funds over the second payment network, wherein the second estimated completion time is calculated based at least on a second date and time of the second transfer of funds over the second payment network was initiated, the second payment network, and the second status.
